(19) United States
(12) Patent Application Publication
(10) Pub. No.: US 2023/0256577 A1
(43) Pub. Date: Aug. 17, 2023

(54) METHOD OF CONTROLLING FIRING MODE FOR ELECTRIC NAIL GUN

(71) Applicant: BASSO INDUSTRY CORP., Taichung (TW)

(72) Inventors: Cheng-En TSAI, Taichung (TW); Chong-Kun HONG, Taichung (TW)

(73) Assignee: BASSO INDUSTRY CORP., Taichung (TW)

(21) Appl. No.: 18/169,406

(22) Filed: Feb. 15, 2023

(30) Foreign Application Priority Data
Feb. 16, 2022 (TW) 111105677

(51) Int. Cl. B25C 1/00; B25C 1/06

(52) U.S. Cl. CPC B25C 1/008; B25C 1/06

(57) ABSTRACT

A method of controlling firing mode for an electric nail gun is provided. The electric nail gun includes a control module that, when operating in a program selecting state in an intelligent firing mode, executes a single firing program or a continuous firing program based on which of a safety switch and a trigger switch of the electric nail gun is being activated . When executing the continuous firing program, the control module forbids execution of a nail firing action when determining that the electric nail gun has not been fired for longer than a predetermined time period.

### CROSS-REFERENCE TO RELATED APPLICATION

This application claims priority to Taiwanese Invention Patent Application No. 111105677, filed on Feb. 16, 2022.

### FIELD

The disclosure relates to an electric nail gun, and more particularly to a method of controlling firing mode for an electric nail gun.

### BACKGROUND

A conventional electric nail gun usually has a single firing mode and a continuous firing mode for a user to choose from according to the user’s needs. A conventional method of choosing between the single firing mode and the continuous firing mode is to let the user control a mode switch that is implemented on the electric nail gun to switch between the two different firing modes.

However, when the user needs to frequently switch between the single firing mode and the continuous firing mode, the user may have to constantly pause his/her task at hand in order to switch between the two different firing modes, and then position the electric nail gun back to where it was left off to resume the task, making the electric nail gun inconvenient to use.

However, when the electric nail gun is in the continuous firing mode, the user may unintentionally keep a trigger switch of the electric nail gun activated when not performing the task, (e.g., when the electric nail gun has just been turned on, or when the user is holding the electric nail gun while moving to another working location). In such a case, since the electric nail gun is in the continuous firing mode, a nail may unintentionally be fired and cause injuries when the user accidentally activates a safety switch of the electric nail gun.

### SUMMARY

Therefore, an object of the disclosure is to provide a method of controlling firing mode for an electric nail gun that can alleviate at least one of the drawbacks of the prior art.

According to the disclosure, a method of controlling firing mode for an electric nail gun including a safety switch, a trigger switch and a control module is provided. The method includes steps of, by the control module, when operating in a program selecting state in an intelligent firing mode, determining which of the safety switch and the trigger switch is being activated to generate a determined result, and executing one of a single firing program and a continuous firing program that corresponds to the determined result, and by the control module, when executing the continuous firing program, forbidding execution of a nail firing action when the control module determines that the electric nail gun has not been fired for longer than a predetermined time period.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an electric nail gun for implementing a method of controlling firing mode for an electric nail gun according to an embodiment of the disclosure.

FIG. 2 is a flow chart illustrating a main program of the method according to the embodiment of the disclosure.

FIG. 3 is a flow chart illustrating an intelligent firing mode of the method according to the embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

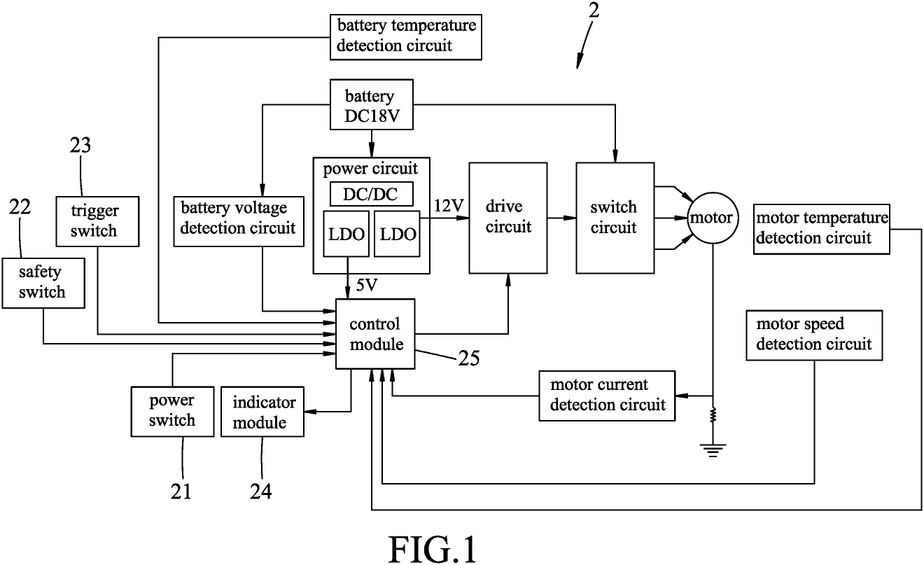

A method of controlling firing mode for an electric nail gun according to an embodiment of the disclosure is performed by an electric nail gun 2 as shown in FIG. 1. The electric nail gun 2 includes a power switch 21, a safety switch 22, a trigger switch 23, an indicator module 24, and a control module 25. The indicator module 24 may be a plurality of light emitting diodes (LEDs). The control module 25 may be a circuit with functions of analog-to-digital conversion (A/D conversion), input/output detection (l/O detection), communication transmission, and pulse-width modulation (PWM) output etc., such as a microcontroller unit (MCU).

In this embodiment, the control module 25 is configured to enter a default firing mode when the electric nail gun 2 is turned on.

When the control module 25 is in the default firing mode, the indicator module 24 shows a first light signal corresponding to the default firing mode. When the control module 25 determines that the safety switch 22 is being activated, and then the trigger switch 23 is being activated while the safety switch 22 is continuously being activated (i.e., not being released since being activated), the control module 25 controls the electric nail gun 2 to execute a nail firing action once (i.e., to fire a nail), and then waits until both the safety switch 22 and the trigger switch 23 are being released to enter an intelligent firing mode. In other words, the control module 25 enters the intelligent firing mode when both the safety switch 22 and the trigger switch 23 become not activated after the nail firing action is executed once in the default firing mode.

In the intelligent firing mode, when neither the safety switch 22 nor the trigger switch 23 has been activated, for longer than a standby time period (i.e., when both the safety switch 22 and the trigger switch 23 remain inactivated for longer than a standby time period), the control module 25 returns to the default firing mode.

When the control module 25 is in the intelligent firing mode, the indicator module 24 shows a second light signal corresponding to the intelligent firing mode, and the control module 25 is in a program selecting state upon entering the intelligent firing mode. The control module 25 in the program selecting state determines which of the safety switch 22 and the trigger switch 23 is being activated to generate a determined result, and executes one of a single firing program and a continuous firing program that corresponds to the determined result (i.e., executes either the single firing program or the continuous firing program based on the determined result).

The indicator module 24 may be configured to show the first light signal and the second light signal in different manners, for example, one is a constant light and the other is a blinking light, or that the two light signals are in different colors.

In this embodiment, when the control module 25 in the program selecting state determines that the safety switch 22 is being activated, the control module 25 executes the single firing program; otherwise, when the control module 25 in the program selecting state determines that the trigger switch 23 is being activated, the control module 25 executes the continuous firing program. The control module 25 returns to the program selecting state when the single firing program or the continuous firing program is terminated.

When the control module 25 is executing the single firing program, and when the trigger switch 23 is being activated while the safety switch 22 is continuously being activated, the control module 25 controls the electric nail gun 2 to execute the nail firing action once, and then waits until both the safety switch 22 and the trigger switch 23 are released (i.e., not activated). The control module 25 terminates the single firing program and returns to the program selecting state when both the safety switch 22 and the trigger switch 23 are released.

When the control module 25 is executing the continuous firing program, the control module 25 controls the electric nail gun 2 to execute the nail firing action once every time the safety switch 22 is being activated while the trigger switch 23 is continuously being activated. The control module 25 terminates the continuous firing program and returns to the program selecting state when both the safety switch 22 and the trigger switch 23 are released.

When the control module 25 is executing the continuous firing program, the control module 25 forbids execution of the nail firing action when the control module 25 determines that the electric nail gun 2 has not been fired for longer than a predetermined time period, and the indicator module 24 may light up a third light signal corresponding to a condition of forbidding the execution of the nail firing action.

When the control module 25 is executing the continuous firing program, the control module 25 times a triggering time period during which the trigger switch 23 is continuously being activated. During the timing of the triggering time period, the control module 25 resets the triggering time period and re-times the triggering time period when the safety switch 22 is being activated. The control module 25 forbids execution of the nail firing action when the triggering time period is longer than the predetermined time period.

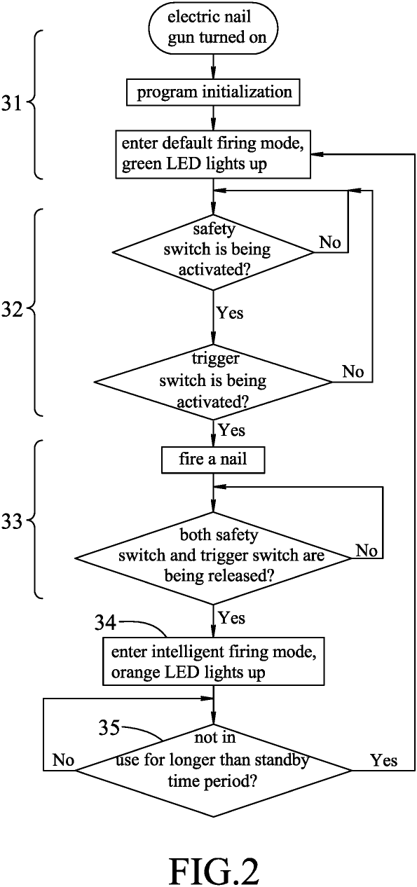

Further referring to FIG. 2, an operation process of the embodiment is illustrated.

In step 31, when the user activates the power switch 21 of the electric nail gun 2, the electric nail gun 2 is turned on and the control module 25 enters the default firing mode. The indicator module 24 may light up a green LED (not shown in the figure) to indicate that the default firing mode is currently active. The flow proceeds to step 32.

In step 32, the control module 25 determines whether the safety switch 22 and the trigger switch 23 are being activated in order, and whether the safety switch 22 and the trigger switch 23 are both being activated at the same time. If both of the determinations are affirmative, the flow proceeds to step 33; otherwise, step 32 is repeated.

In step 33, the control module 25 controls the electric nail gun 2 to execute the nail firing action once, and determines whether both the safety switch 22 and the trigger switch 23 are being released. If affirmative, the flow proceeds to step 34; otherwise, the control module 25 continues to determine whether both the safety switch 22 and the trigger switch 23 are being released.

In step 34, the control module 25 enters the intelligent firing mode, and the indicator module 24 may light up an orange LED (not shown in the figure) and turn off the green LED to indicate that the intelligent firing mode is currently active.

In step 35, when the control module 25 is operating in the intelligent firing mode, and when both the safety switch 22 and the trigger switch 23 remain inactivated (i.e., the electric nail gun 2 is not in use) for longer than the standby time period (e.g., thirty minutes), the control module 25 returns to the default firing mode; otherwise, the control module 25 continues to operate in the intelligent firing mode and to keep timing the length of time during which neither the safety switch 22 nor the trigger switch 23 has been activated.

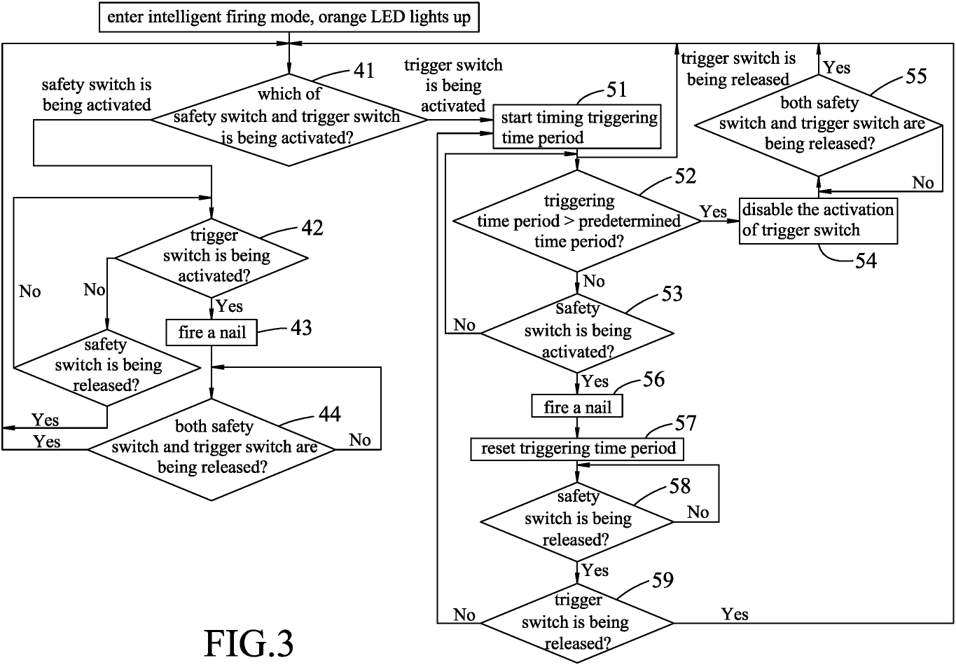

Further referring to FIG. 3, the flow proceeds to step 41 after the control module 25 enters the intelligent firing mode. In step 41, the control module 25 operates in the program selecting state in the intelligent firing mode. The control module 25 determines which of the safety switch 22 and the trigger switch 23 is being activated to generate the determined result, and executes one of the single firing program and the continuous firing program that corresponds to the determined result. When it is determined that the safety switch 22 is being activated, the flow proceeds to steps 42 to 45 to execute the single firing program; otherwise, when it is determined that the trigger switch 23 is being activated, the flow proceeds to steps 51 to 59 to execute the continuous firing program.

In step 42, the control module 25 determines, while the safety switch 22 is continuously being activated, whether the trigger switch 23 is being activated. Upon determining that the trigger switch 23 is being activated, the flow proceeds to step 43; otherwise, the flow proceeds to step 45.

In step 43, the control module 25 controls the electric nail gun 2 to execute the nail firing action once, and the flow proceeds to step 44.

In step 44, the control module 25 determines whether both the safety switch 22 and the trigger switch 23 are released. Upon determining that both the safety switch 22 and the trigger switch 23 are released, the control module terminates the single firing program and the flow returns to step 41. Otherwise, the control module 25 repeats step 44.

In step 45, the control module 25 determines whether the safety switch 22 is released. When the control module 25 determines that the safety switch 22 is released, the flow returns to step 41; otherwise, when the control module 25 determines that the safety switch 22 is still being activated (i.e., not released), the flow returns to step 42.

In other words, when the control module 25 is operating in the program selecting state in the intelligent firing mode, and when the user activates the safety switch 22 and not the trigger switch 23, it means that the user selects a single firing mode, and the control module 25 executes the single firing program. When executing the single firing program, and when the trigger switch 23 is being activated while the safety switch 22 is continuously being activated, the control module 25 controls the electric nail gun 2 to execute the nail firing action once and then waits until both the safety switch 22 and the trigger switch 23 are released. In other words, when the user intends to fire a nail in the single firing mode, the user may activate the safety switch 22 first, and then activate the trigger switch 23 while the safety switch 23 is continuously being activated. The control module 25 terminates the single firing program when both the safety switch 22 and the trigger switch 23 are released and returns to the program selecting state.

In step 51, the control module 25 times the triggering time period during which the trigger switch 23 is continuously being activated. Once the trigger switch 23 is being released during the timing of the triggering time period, the flow returns to step 41.

In step 52, the control module 25 determines whether the triggering time period is longer than the predetermined time period (e.g., five seconds). If affirmative, the flow proceeds to step 54; otherwise, the flow proceeds to step 53.

In step 53, the control module 25 determines whether the safety switch 22 is being activated while the trigger switch 23 is continuously being activated. If affirmative, the flow proceeds to step 56; otherwise, the flow returns to step 52.

In step 54, the control module 25 forbids the nail firing action. At this time, the control module 25 may control the orange LED to blink to indicate that the nail firing action is forbidden, and the flow proceeds to step 55.

In other words, when the control module 25 is executing the continuous firing program, and when the user has not activated the safety switch 22 for a time period longer than the predetermined time period, the control module 25 disables the activation of the trigger switch 23. When the nail firing action is forbidden, even if the user activates the safety switch 22 while the trigger switch 23 is continuously being activated, the nail firing action will not be executed.

In step 55, the control module 25 determines whether both the safety switch 22 and the trigger switch 23 are released. The flow returns to step 41 when the control module 25 determines that both the safety switch 22 and the trigger switch 23 are released. Otherwise, the control module 25 repeats step 55. In other words, when it is determined in step 52 that the triggering time period is longer than the predetermined time period, the control module 25 waits until both the safety switch 22 and the trigger switch 23 are released to return to the program selecting state (i.e., step 41).

In step 56, the control module 25 controls the electric nail gun 2 to execute the nail firing action once, and the flow proceeds to step 57.

In step 57, the control module 25 resets the triggering time period to zero in response to the activation of the safety switch 22 in step 53, and the flow proceeds to step 58.

In step 58, the control module 25 determines whether the safety switch 22 is released. If affirmative, the flow proceeds to step 59; otherwise, repeat step 58.

In step 59, the control module 25 determines whether the trigger switch 23 is released. If affirmative, the flow returns to step 41; otherwise, the flow returns to step 51 to re-time the triggering time period.

In other words, when the control module 25 is operating in the program selecting state in the intelligent firing mode, and when the user activates the trigger switch 23 and not the safety switch 22, it means that the user selects a continuous firing mode, and the control module 25 executes the continuous firing program. When executing the continuous firing program, the control module 25 controls the electric nail gun 2 to execute the nail firing action once every time the safety switch 22 is being activated while the trigger switch 23 is continuously being activated. In other words, when the user intends to fire one or more nails in the continuous firing mode, the user may activate the trigger switch 23 first, and then activate the safety switch 22 as many times as needed while the trigger switch 23 is continuously being activated. The control module 25 terminates the continuous firing program and returns to the program selecting state when both the safety switch 22 and the trigger switch 23 are released.

In summary, the control module 25 in the program selecting state in the intelligent firing mode determines which of the safety switch 22 and the trigger switch 23 is being activated to generate the determined result, and executes one of the single firing program and the continuous firing program that corresponds to the determined result. The user may select between the single firing mode and the continuous firing mode by changing the order of activating the safety switch 22 and the trigger switch 23. Since activating the safety switch 22 and activating the trigger switch 23 are both necessary when using the electric nail gun 2, the user does not need to perform additional operations to switch between the single firing program and the continuous firing program, making the electric nail gun 2 convenient to use when a frequent switching between the two different firing modes is needed.

The indicator module 24 shows the first light signal, the second light signal and the third light signal respectively for the default firing mode, the intelligent firing mode, and the condition under which the execution of the nail firing action is forbidden, allowing users to quickly identify which firing mode or condition the electric nail gun 2 is currently in.

When the control module 25 is executing the continuous firing program, and when the electric nail gun 2 has not been fired for longer than the predetermined time period, the control module 25 forbids execution of the nail firing action. This may prevent the electric nail gun 2 from staying in the continuous firing mode for a long time, thus avoiding risks of accidentally firing a nail from the electric nail gun 2 by mistake.

Having the electric nail gun 2 execute the nail firing action once in the default firing mode before entering the intelligent firing mode, which allows the user to select the continuous firing mode, may avoid risks of accidentally firing nails due to the user mistakenly selecting the continuous firing mode at the moment of turning on the electric nail gun 2.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of controlling firing mode for an electric nail gun, the electric nail gun including a safety switch, a trigger switch and a control module, the method comprising steps of:
by the control module, when operating in a program selecting state in an intelligent firing mode, determining which of the safety switch and the trigger switch is being activated to generate a determined result, and executing one of a single firing program and a continuous firing program that corresponds to the determined result; and
by the control module, when executing the continuous firing program, forbidding execution of a nail firing action when the control module determines that the electric nail gun has not been fired for longer than a predetermined time period.

2. The method as claimed in claim 1, the electric nail gun further including an indicator module, and the method further comprising steps of, by the indicator module:
showing a first light signal when the control module operates in the intelligent firing mode; and
showing a second light signal when the control module determines that the electric nail gun has not been fired for longer than the predetermined time period, the second light signal being different from the first light signal.

3. The method as claimed in claim 1, wherein the step of determining whether the safety switch or the trigger switch is being activated to generate the determined result, and executing one of the single firing program and the continuous firing program that corresponds to the determined result includes:
executing the single firing program when it is determined that the safety switch is being activated; and
executing the continuous firing program when it is determined that the trigger switch is being activated.

4. The method as claimed in claim 3, further comprising steps of, by the control module, when executing the single firing program:
when the trigger switch is being activated while the safety switch is continuously being activated, controlling the electric nail gun to execute the nail firing action once, and then waiting until both the safety switch and the trigger switch are not activated; and
terminating the single firing program and returning to the program selecting state when both the safety switch and the trigger switch are released.

5. The method as claimed in claim 3, further comprising a step of, by the control module, when executing the continuous firing program, controlling the electric nail gun to execute the nail firing action once every time the safety switch is being activated while the trigger switch is continuously being activated.

6. The method as claimed in claim 3, further comprising a step of, by the control module, when executing the continuous firing program, terminating the continuous firing program and returning to the program selecting state when both the safety switch and the trigger switch are released.

7. The method as claimed in claim 3, further comprising steps of, by the control module, when executing the continuous firing program:
timing a triggering time period during which the trigger switch is continuously being activated;
during the timing of the triggering time period, resetting the triggering time period and re-timing the triggering time period when the safety switch is being activated; and
forbidding execution of the nail firing action when the triggering time period is longer than the predetermined time period.

8. The method as claimed in claim 1, further comprising steps of:
by the control module, entering a default firing mode when the electric nail gun is turned on; and
by the control module, entering the intelligent firing mode after controlling the electric nail gun to execute the nail firing action once in the default firing mode.

9. The method as claimed in claim 8, the electric nail gun further including an indicator module, and the method further comprising a step of, by the indicator module, showing a default-mode light signal when the control module operates in the default firing mode.

10. The method as claimed in claim 9, further comprising a step of, by the indicator module, showing an intelligent-mode light signal when the control module operates in the intelligent firing mode, wherein the indicator module shows the default-mode light signal and the intelligent-mode light signal in different manners.

11. The method as claimed in claim 8, further comprising a step of, by the control module, when operating in the intelligent firing mode, and when neither the safety switch nor the trigger switch has been activated, for longer than a standby time period, returning to the default firing mode.
